(19) United States
(12) Patent Application Publication
(10) Pub. No.: US 2003/0151980 A1
(43) Pub. Date: Aug. 14, 2003

(54) Color referenced multi-time watch

(76) Inventor: Isador Farash, South Hackensack, NJ (US)

Correspondence Address: Isador Farash, 40 Ruta Court, South Hackensack, NJ, 07606, US

(21) Appl. No.: 10/075,645

(22) Filed: Feb. 13, 2002

(51) Int. Cl. G04B 19/22; A44C 5/00; G04B 37/00

(52) U.S. Cl. 368/21; 368/281

(57) ABSTRACT

A color referenced multi-time keeping timepiece includes at least two clocks on the same watch. These at least two clocks may be positioned one above the other, at a diagonal angle relative to each other, or side by side. The lens of one or both clocks is tinted and the minute and hour hands of each clock are brightly colored. The colored hands are fluorescent, making them easy to see, and also causing them to contrast with the color of the tinted lens. The face of each clock is phosphorescent, making the clock easy and convenient to read in low-light conditions. The tinting of one or both lenses provides a mental reference point for different time zones while the contrasting colors of the watch hands relative to the tinted lenses make it easy to see the necessarily smaller watch hands.

### FIELD OF THE INVENTION

This invention relates generally to watches. In particular, the invention concerns multiple clock mechanisms contained within the same watch. The multiple clock mechanisms are used to tell the time in two or more different time zones.

### BACKGROUND OF THE INVENTION

The earth is divided into twenty-four geographic areas, each of which has a corresponding time zone. Clocks and watches within a time zone are generally set to correspond to the time zone in which they are located. Each time zone is generally one hour later than the adjacent time zone to the west. Each time zone is defined by its distance, east or west, from Greenwich, England.

When a traveler must move rapidly between geographic areas that have different time zones, it is desirable to be able to determine, at a glance, the time in each geographic area simultaneously.

Analog watches have been designed that provide multiple clocks in one watch. For example, see U.S. Pat. No. 3,277,646 to Howard, Sr. and U.S. Pat. No. 5,339,293 to Namiyama et al. Howard and Namiyama show numerous small clocks on the face of a single watch. In Howard, each small clock is identical in size and shape, while in Kamiyama, each of the small clocks are identical, but the design also includes a larger clock that covers the entire watch surface.

Digital watches have also been designed that show multiple times simultaneously. For example, see U.S. Pat. No. 5,051,967 to Dismond, III.

What is needed is a timepiece that, first, allows the user to easily distinguish multiple time zones, and, second, allows the user to easily distinguish between multiple displays on the same timepiece through the use of contrasting color combinations.

### SUMMARY OF THE INVENTION

The present invention provides a watch with multiple clocks therein. At least one of the clocks includes a tinted lens to provide the wearer with a mental reference point for each clock. The different lenses correspond to different time zones.

Each of the clocks in the inventive watch includes an hour hand of a color in direct contrast to the pastel color of the watch lens, and one or both clocks will also include a minute hand of a similar color. The colored hands contrast dramatically with the tinted lens. The contrast between the watch hands and the watch lens makes it easy for the wearer to tell what time it is on each individual watch.

A bright phosphorescent color can be applied to the watch hands in order to create a dramatic contrast between the hands and the lenses. The phosphorescent color on the watch hands facilitates easy reading of the various clock faces.

### BRIEF DESCRIPTION OF THE DRAWINGS

FIG. 1 illustrates an embodiment of the inventive watch wherein the first and second clock mechanisms are positioned one above the other.

FIG. 2 illustrates an embodiment of the inventive watch wherein the first and second clock mechanisms are positioned at a diagonal angle relative to each other on the face of the inventive multiple time zone watch.

FIG. 3 illustrates a modified embodiment of the inventive watch shown in FIG. 2 wherein a shaded tinting on one of the lenses is distinguishable from the other lens.

FIG. 4 illustrates an embodiment of the inventive watch wherein the first and said second clock mechanisms are positioned side by side, and one or both clocks is covered by a lens with shaded tinting.

### DETAILED DESCRIPTION OF INVENTION

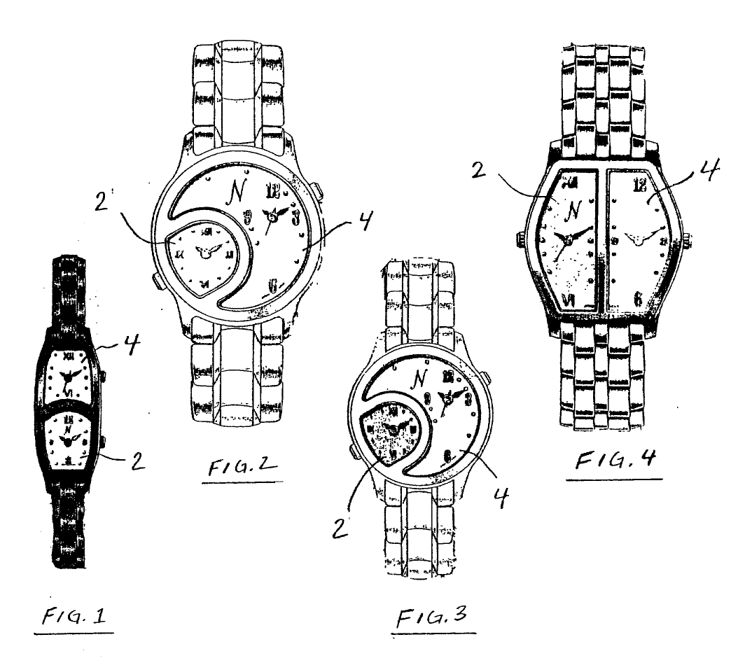

Referring now to each of the figures, in which multiple embodiments of the inventive watch are shown. Each of FIGS. 1-4 shows two clocks contained within a watch. Although the watches show two clocks, additional, multiple clocks are also contemplated.

The clocks can be oriented over and under (FIG. 1) diagonal relative to the watch face (FIGS. 2 and 3) and side by side (FIG. 4).

The wearer typically sets one of the clocks to his home time zone and the other clock to the time zone of the geographic area in which he or she is visiting.

One or both of the clocks includes a tinted lens. The tinted lens provides a mental reference point for the user. Instead of having to remember which of the clocks is home or away, all that needs to be remembered is the color of one or both of the tinted lenses. The tint is usually of a medium tint, such as pastel color. The pastel colors may include such colors as pink, mint green, pale blue, yellow, and the like.

The leftmost clock 2, in FIGS. 3 and 4, shows a shaded tint that is distinguishable from the rightmost clock 4, which is clear. As described herein, if preferred, each of the clocks may be tinted in a pastel color to even more dramatically distinguish the clocks and the corresponding time zones.

The hour and minute hands of each watch are colored. At least one clock on a watch will have a minute, as well as an hour hand. Two minute hands are not strictly necessary. Although both minute hands may be present on one watch, they usually are not, since minutes are identical almost world-wide. The colors of the hands are preferably bright, phosphorescent colors, and may include such colors as red, orange, blue, or any other desired color.

The colors applied to the hands are specifically calculated to create a striking contrast with the color of the tint on the lens and the faces. Because the individual clocks are necessarily reduced in size to fit on the watch, the striking contrast compensates for the reduced size and makes the clock hands very easy to read quickly and efficiently.

The color applied to the face may also be luminescent. This creates a surprising and attractive glow, which may be in a pastel color such as creamy white, that contrasts with the tinted lens when light is reflected off the phosphorescent hands, and passes through said lens. In daylight, the phosphorescent hands shine brightly through the lens. At night, the luminescent dial glows, causing the hands to appear dark against the tinted dial. This creates a silhouette of the hands which makes them easily readable in low-light conditions. Alternatively, the hands may be luminescent and the face may be coated with a phosphor.

The watches may be made in various configurations for both the male and female wearer, some of which are shown in the drawings. The watch face may be circular (see FIGS. 2 and 3), in which case the first, larger, clock has the shape of ¾ moon, and appears wrapped around the smaller, horseshoe shaped clock. The larger clock's hands are set slightly off center to the upper right of the ¾ moon shape. The second clock appears as a horseshoe shaped inset on the lower left side of the watch face. This particular circular style comes with a larger total watch face for men (FIG. 2), and a smaller total watch face for women (FIG. 3). Both watches may be equipped with a metal wristband made up of separate links. The links used to create the wristband come in larger or smaller sizes for men and women, respectively.

The second embodiment (FIG. 1) features a watch face resembling a rectangle in which the longer pair of opposing sides appears to have been bent outward. Since the woman's version of this design is slender and delicate, the two clocks have been set one over the other, with a curved dividing line running horizontally through the center of the entire watch face. This dividing line delineates the two clocks, and is connected to the metal watch face rim. The wristband attached to this watch consists of metal links which may be much smaller than in any of the other designs.

The third embodiment (FIG. 4) features a watch face similar to the one described above, with a rectangular watch face in which the longer pair of opposing sides appears to have been bent outward. In this case, the entire watch face is larger, as the design is intended for a larger, man's watch. This extra space allows the two clocks to be positioned adjacent to one another, separated by a vertical line that is part of the watch face rim, and which runs between them. The wristband of this design also includes metal links.

The numerals on the clock faces may be Arabic or Roman, and generally each of at least two clocks on a particular watch will employ a different style of numeral. This further assists the reader in distinguishing between the separate clocks.

The clocks used in the inventive watch are analog, but digital mechanisms may also be contemplated for use. Each watch is equipped with a small time-setter mechanism for each clock on the watch, currently two per watch. These mechanisms appear in the form of small metal buttons with ridged sides that are affixed to the rim of the watch face. When pulled up slightly from the rim, the user may turn the time-setter mechanism in order to set the hands to the correct time. Once the correct time is set, the user pushes the time-setter button back down toward the rim and sets it in place.

Additional variations of the inventive watch are also possible and contemplated that will fall within the spirit and scope of this invention as further defined by the claims that follow.

What is claimed is:

1. A multiple time zone watch comprising:
a. A first and a second clock mechanism wherein said first clock mechanism has a tinted lens that is distinguishable in color from the lens on said second clock mechanism;
b. Said first clock mechanism also having at least two hands, one of which being an hour hand and one of which being a minute hand; said hands of said first clock mechanism having a color thereto; the color of said two hands being of a color that contrasts with the color of said tinted lens of said first clock mechanism; and
c. Said second clock mechanism also having at least one hand.

2. A multiple time zone watch as claimed in claim 1 wherein said first and said second clock mechanisms are positioned next to each other, side by side.

3. A multiple time zone watch as claimed in claim 1 wherein said first clock has a clock face covered with a luminescent material that contrasts with the color of said clock hands.

4. A multiple time zone watch as claimed in claim 1 wherein said first and said second clock mechanisms are positioned one above the other.

5. A multiple time zone watch as claimed in claim 1 wherein said first and said second clock mechanisms are positioned at a substantially diagonal angle relative to each other on the face of said multiple time zone watch.

6. A multiple time zone watch as claimed in claim 1 wherein the color applied to each of said hands of each of said first clock mechanism is phosphorescent.

7. A multiple time zone watch as claimed in claim 1 wherein said second clock also includes a tinted lens.

8. A multiple time zone watch as claimed in claim 6 wherein the color of said tinted lens is a medium tint pastel.

9. A multiple time zone watch as claimed in claim 1 wherein the color applied to each of said hands of each of said watch mechanisms is phosphorescent whereby light reflecting off said hands onto said tinted lens causes said tinted lens to glow.

10. A multiple time zone watch comprising:
a. A first clock mechanism having a tinted lens; a second clock mechanism having a tinted lens that is distinguishable in color from the color of said tinted lens on said first clock mechanism;
b. Said first clock mechanism also having at least two hands, one of which being an hour hand and one of which being the minute hand; said hands of said first clock mechanism having a color applied thereto; the color of said two hands being of a color that contrasts with the color of said tinted lens of said first clock mechanism; and
c. Said second clock mechanism also having at least two hands, the first of which being an hour hand and the second of which being the minute hand; said hands of said second clock mechanism having a color applied thereto; the color of said at least two hands being of a color that contrasts with the color of said tinted lens of said second clock mechanism.

11. A multiple time zone watch as claimed in claim 9 wherein the colors of said distinguishable tinted lenses are selected from the group consisting of medium tint pastel colors.
